(19) United States
(12) Patent Application Publication
(10) Pub. No.: US 2016/0376099 A1
(43) Pub. Date: Dec. 29, 2016

(54) CONTAINER HANDLING SYSTEM WITH STERILE ROOM AND LIQUID DISCHARGE FROM SAID STERILE ROOM AND METHOD OF HANDLING CONTAINERS

(71) Applicant: KRONES AG, Neutraubling (DE)

(72) Inventors: Martin Wagner, Regensburg (DE); Kai-Uwe Dreger, Neutraubling (DE)

(21) Appl. No.: 15/188,575

(22) Filed: Jun. 21, 2016

(30) Foreign Application Priority Data
Jun. 25, 2015 (DE) 10 2015 110 214.5

(51) Int. Cl. B65D 90/22; A61G 10/00; F17C 13/00

(52) U.S. Cl. CPC B65D 90/22; F17C 13/00; A61G 10/005

(57) ABSTRACT

System for handling containers having a movable carrier on which at least one handling station for handling the containers is arranged, wherein the handling station is transported along a predetermined transport path, and wherein the system has a clean room inside which the containers are handled, wherein this clean room is delimited relative to an unsterile environment by at least one wall. According to the invention at least one wall of the clean room is at least in sections inclined relative to a horizontal plane in such a way that a liquid can be led out of the clean room along this wall.

### CROSS-REFERENCE TO RELATED APPLICATIONS

This application claim priority to German patent application 10 2015 110 214.5, filed Jun. 25, 2015, which is incorporated as if fully rewritten herein.

### STATEMENT REGARDING FEDERALLY SPONSORED RESEARCH OR DEVELOPMENT

Not applicable.

### TECHNICAL FIELD

The present disclosure relates generally to a container handling system having at least one sterile room and the capacity of liquid discharge from said sterile room and method of handling containers.

Illustrative examples of various embodiments of the invention, all provided by way of example and not limitation, are described.

### BRIEF DESCRIPTION OF THE ILLUSTRATIONS

Without limiting the scope of the as disclosed herein and referring now to the drawings and figures:

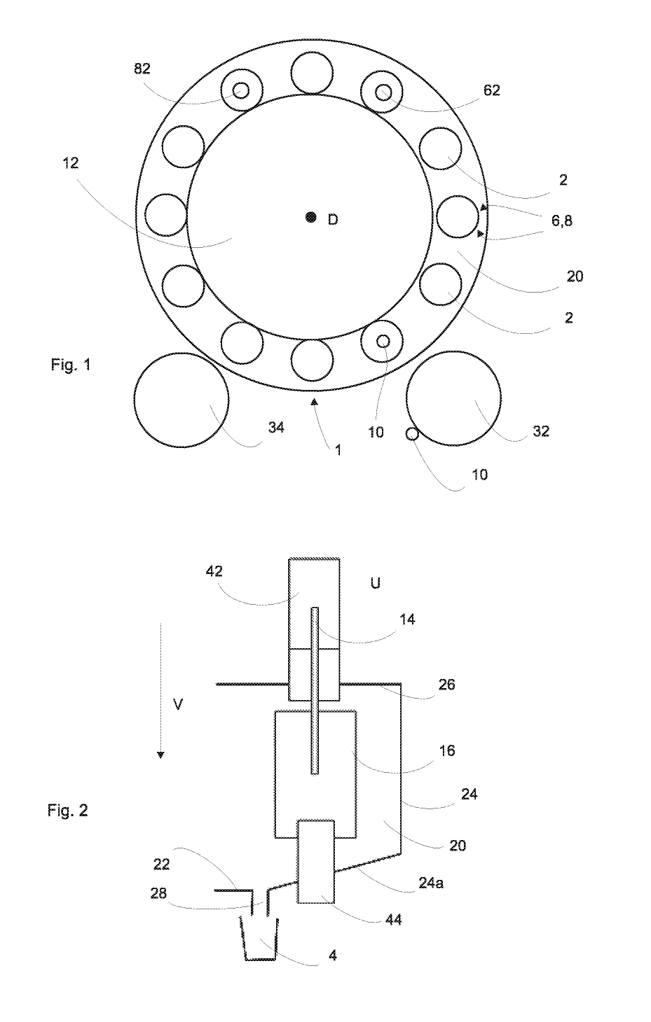

FIG. 1 shows a schematic representation of a system according to an embodiment of the invention for transforming plastics material parisons into plastics material containers;

FIG. 2 shows a schematic sectional representation of a system according to the invention in a first embodiment;

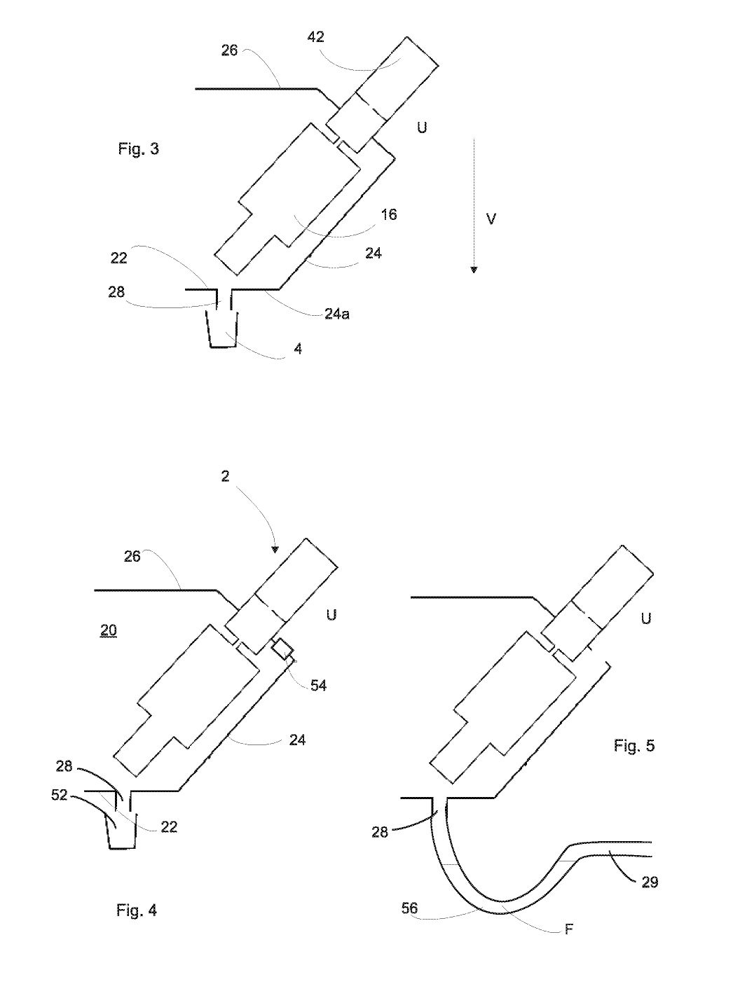

FIG. 3 shows a schematic sectional representation of a system according to the invention in a second embodiment;

FIG. 4 shows a further schematic representation of a system according to an embodiment of the invention; and

FIG. 5 shows a further schematic representation of a system according to an embodiment of the invention.

These illustrations are provided to assist in the understanding of the exemplary embodiments of a container handling system having at least one sterile room and the capacity of liquid discharge from said sterile room and method of handling containers. and materials related thereto described in more detail below and should not be construed as unduly limiting the specification. In particular, the relative spacing, positioning, sizing and dimensions of the various elements illustrated in the drawings may not be drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

The invention is described below in more detail with reference to FIGS. 1-5. The present invention relates to a container handling system. The most varied container handling systems are known from the prior art, such as for example filling machines, labelling machines or also blow molding machines, which transform or blow mold respectively plastics material parisons to produce plastics material containers. The invention described here is basically applicable to any of these machines, in particular when they operate under sterile chamber conditions.

As a rule plastics material containers are first of all blow molded in blow molding machines and are then filled with product in a filler. A novel product group which is known from the internal prior art from the applicant currently relates to the blow molding and filling of the containers on one single machine. In this case at the outset the container is produced, as in a conventional blow molding machine, by a blow molding process and in particular a stretch blow molding process of a plastics material parison (preform) in a blow mold.

Following this, the container produced in this way is filled with a liquid, in particular the product, such as for instance a beverage. Then the filled container is removed from the blow mold. In this case it is also conceivable for this filling process to be assisted by a negative pressure. It is also possible for the container to be shaped hydraulically or directly respectively by the product.

Due to the envisaged combination of blow molding of the container and filling thereof, a container which spills or bursts can for example lead to liquid collecting in the region of the blow molding and mold filling stations, so that hygienic and optical problems can occur. Also in other container handling machines, due to the dripping of liquid, corresponding contaminations can occur, which are disruptive in particular in the case of sterile applications. Some beverages require sterile treatment steps such as for instance sterile bottling. Particularly in the case of such beverages, contaminations, in particular inside a clean room, are regarded as particularly problematic.

Therefore the object of the present invention is to improve the hygiene of such machines. In particular, problems due to leakage or spraying of liquid, in particular inside a clean room, should be avoided. These objects are achieved according to the invention by the subject matters of the independent claims. Advantageous embodiments and further developments form the subject matter of the dependent claims.

A system according to an embodiment of the invention for handling containers has a movable carrier on which at least one handling station for handling the containers is arranged. In this case the handling station is transported along a predetermined transport path. Furthermore, the system has a clean room inside which the containers are handled, wherein this clean room is separated by means of at least one wall from an unsterile environment. The unsterile environment may for example be the space in which the corresponding system is located, but the expression “unsterile environment” also relates generally to those environments which by comparison with the actual sterile room have a lower sterility level, for instance so-called grey rooms.

According to an embodiment of the invention at least one wall of the clean room is at least in sections inclined relative to a horizontal plane in such a way that a liquid can be led out of the clean room along this wall. The movable carrier is advantageously a rotatable carrier. Several handling stations are advantageously disposed on this carrier. The system advantageously also has several walls which in each case delimit the said clean room. Therefore, preferably, the liquid can also be led out of the clean room by means of the said wall. Advantageously, the inclined wall serves at least in sections for guiding and/or leading the said liquid. Alternatively or additionally (in particular in the interior of the clean room) a liquid guiding element can also be provided, along which the said liquid flows off due to gravity.

In a further advantageous embodiment the wall which is inclined relative to the horizontal plane may be a wall which delimits the clean room. However, it would also be possible for a further wall, which is inclined for the purpose of drawing off liquid inside the clean room, to be constructed in particular in the interior of the clean room.

The movable carrier is preferably a rotatable carrier. A plurality of handling stations are preferably arranged on this carrier. The clean room is preferably constructed at least in some sections in an annular and/or toroidal form around the transport path of the plastics material containers. In addition several walls are preferably provided for delimiting the clean room. The clean room is preferably formed by the internal space formed by these walls.

In a further advantageous embodiment the system has a draining device in order to drain off liquid from the clean room. In this case for example an opening and/or a pipe or a conduit, by means of which liquid can exit from the clean room, can be provided at a lower position on this clean room or for example a bottom wall respectively.

It is therefore proposed, in one embodiment, that an oblique base region is provided, which is configured so that product residues, in particular liquid product residues, can run off and in particular can run off into a collecting channel. In this way on the one hand product residues run off from through containers which spill or burst and on the other hand automatic cleaning of the clean room is possible.

The system preferably has a collecting device for collecting the liquid medium which is drained off out of the clean room or is to be drained off out of the clean room. In this case this collecting device is advantageously disposed outside the said clean room. This collecting device may for example be a container or also an annular channel. However, such a collecting device can also already be provided inside the clean room, for instance in the form of a channel which collects the liquid conveyed by the inclined surface.

In a further advantageous embodiment the system has at least one arrangement for supplying the containers with a gaseous medium and/or at least one arrangement for filling the containers with a liquid medium. Advantageously both an arrangement for supplying the containers with a gaseous medium and an arrangement for filling the containers with a liquid medium are provided. Each handling unit preferably has both an arrangement for supplying the plastics material parisons with the gaseous medium and also an arrangement for filling the containers. Thus this is advantageously a stretch blow molding machine or a blow molding machine respectively equipped with a filling function or a so-called mold filling machine. In a mold filling machine plastics material parisons are filled directly with the product to be introduced and as a result are expanded.

In a further advantageous embodiment the handling station has a filling element for filling the containers and a supply element for supplying the containers with a gaseous medium. The handling station advantageously also has a stretching rod. The handling station also advantageously has a mold, in particular a blow mold, which forms a hollow space inside which the plastics material parison is expanded. In this case the expansion of the plastics material parison is performed by blowing air or by filling with a filling material. A combination of these procedures would also be conceivable.

In a further advantageous embodiment the system has a pressure generating device in order to generate an overpressure in the clean room relative to the unsterile environment.

In a further advantageous embodiment the system has a gas barrier which prevents a gaseous medium (e.g. unsterile air) from entering the clean room via the draining device. Thus for example it may be possible that a liquid is discharged from the clean room via the draining device, but nevertheless the barrier prevents a gaseous medium from entering the system via the draining device. Thus for example in the case of a stationary clean room, for example in the case of clocked machines, the collecting channel can be emptied by means of a pipeline. In this case this pipeline can be constructed as a siphon if a specific overpressure has to be maintained in the clean room. However, it would also be possible for a sterile medium, for example sterile air, to enter the clean room via the draining device.

Advantageously a collecting channel in which liquid running off can be collected is arranged in the clean room. In this case this collecting channel can also extend obliquely with respect to a horizontal plane, so that liquid can enter the collecting channel, for example in the direction of a discharge opening.

The siphon-like configuration of a discharge pipe can serve as a gas barrier if for example liquid can collect in this siphon and thereby prevent the passage of gas. In the case of rotary machines the said collecting channel could be emptied for example by means of an annular channel. This annular channel may be a component of a water lock.

Therefore the gas barrier is advantageously formed as a siphon or as a water lock. When a water lock is used, a part of the wall delimiting the clean room is arranged in a stationary manner and another part rotates. The channel which is a component of the water lock can likewise rotate or it may be stationary. Likewise a wall of the respective other (rotating or stationary part) engages in this channel and in this way a water barrier is achieved.

In particular if a water lock is provided, in addition to this water lock an emptying device is also provided, for example by means of a pipe and/or a (in particular annular or circular) collecting tray. In addition a cleaning device for cleaning the clean room could be provided, such as for instance a CIP cleaning device which is known per se from the prior art. Thus for example several nozzles located in the clean room could be provided in order to achieve automatic cleaning of the clean room and or of components of the individual handling stations such as for instance the blow molds.

Furthermore, the system can have several water locks, for example two water locks, in order to shield the clean room relative to the environment. Therefore the clean room preferably has at least two walls which are movable with respect to one another, wherein each of these walls delimits the clean room.

In a further advantageous embodiment at least one handling station is oriented obliquely relative to a vertical direction. This means that in this handling station also the container to be expanded or to be filled respectively is preferably arranged obliquely. Therefore in this case in particular a longitudinal direction of the plastics material parisons to be handled extends obliquely relative to a vertical direction. In such a system also the above-mentioned stretching rod could be moved in a straight line but obliquely. In a further advantageous embodiment the inclination of a wall region could be adapted to an angle of inclination of an obliquely disposed blow molding or mold filling station respectively, in order in this way to achieve optimal utilization of space. Thus it would be possible for the inclination of the said wall to differ from the inclination of the handling station by no more than 20%, preferably by no more than 10%.

The wall and/or generally the draining device for draining off the liquid medium is preferably inclined at an angle greater than 10°, preferably greater than 20°, preferably greater than 30°, relative to a horizontal plane. This angle is preferably smaller than 80°, preferably smaller than 70° and particularly preferably smaller than 60°.

In a further advantageous embodiment a base region of the clean room is advantageously designed to slope downwards in the radial direction towards the exterior, so that the run-off of liquid is assisted by centrifugal force (in an operating mode of the system).

Furthermore, the present invention relates to a method for handling containers, wherein the containers are moved by means of handling stations along a predetermined transport path (and during this transport are preferably handled in a predetermined manner, for example filled or expanded), and wherein during handling the containers are transported at least intermittently inside a clean room, wherein this clean room is delimited relative to an unsterile environment by means of at least one wall. Advantageously a liquid is discharged at least intermittently from this clean room. In particular this is liquid which runs off involuntarily inside the clean room, for example product which inadvertently has not been introduced into the container to be filled. Liquid sprayed inside the clean room is preferably drained off inside the clean room, that is to say in particular liquid which has not reached the container as intended or which is flushing liquid for flushing and/or cleaning the clean room.

The system advantageously has clean room elements or supply devices respectively which supply an internal space of the clean room, for cleaning, with a cleaning fluid or also with a sterilizing agent.

The liquid is advantageously drained off by means of an inclined surface of at least one wall. This is advantageously a wall which delimits the clean room.

Advantageously the containers are both expanded and also filled inside the clean room. Therefore the containers or corresponding plastics material parisons are preferably supplied with a gaseous medium. These plastics material parisons are also filled with a liquid. In this case it would also be possible for the filling with the liquid also to be accompanied by an expansion of the plastics material parison or the container is expanded by means of the liquid to be introduced respectively.

Advantageously the same stations perform both expansion and also filling and also the containers are expanded and also filled.

### LIST OF REFERENCE SIGNS

1 system
2 transforming stations/handling stations
4 collecting device
6 transforming device
8 filling device
10 plastics material parisons
12 rotatable carrier
14 stretching rods
16 (blow) mold
20 clean room
22, 24, 26 walls
24a wall portion
28 outlet/draining device
29 discharge device
32 delivery device
34 take-off device
42 driving device
44 further carrier
52, 54 water locks
56 siphon
62 supply element
82 filling elements
D axis of rotation
V vertical direction
U environment
F liquid
   With regard now to FIGS. 1-5; FIG. 1 shows a schematic representation of a system 1 according to the invention. In this case this system has a delivery device 32 which delivers plastics material parison 10 to a plurality of (only schematically illustrated) transforming stations 2. This delivery device is preferably a transport starwheel, which delivers the plastics material parisons 10 to the individual handling devices 2. Preferably this is a so-called pitch reduction starwheel, which changes and in particular increases the spacing between the individual plastics material parisons 10.

The reference 34 designates a take-off device, which in turn takes off expanded and filled containers. This may again be a transport starwheel. Furthermore, the device has a carrier 12 which is rotatable about an axis of rotation D on which a plurality of handling stations 2 are arranged. In this case these handling stations in each case have filling elements 82, only illustrated singly for the sake of simplicity, as well as supply devices 62, which expand the plastics material parisons 10 to form the plastics material containers. These supply devices can for example have so-called blow molding nozzles, which can be applied to the mouths of the plastics material parisons, in order to supply blowing air to these plastics material parisons in order to expand them.

The reference numeral 20 designates a clean room within which the handling stations 2 and also with them the plastics material parisons to be handled are transported. Sterile conditions can be maintained inside this clean room 20. Furthermore, the clean room 20 is sealed by means of at least one sealing means relative to an (unsterile) environment U. Unlike what is shown in FIG. 1, the clean room can also extend further, for example as far as a closure device which closes the filled containers by means of closures.

The reference numeral 6 relates as a whole to a transforming device—in this case an individual transforming station. The reference numeral 8 designates a filling device which fills the transformed containers. These two devices 6, 8 are components of each individual handling station 2, wherein this is only shown on one handling station 2 in FIG. 1 for better clarity. In the embodiment shown in FIG. 1 the transforming devices and the filling devices are in each case with one another and therefore perform both functions. As mentioned above, on the one hand this can take place by first of all expanding the plastics material parison by means of compressed air and filling them in the system 1. On the other hand, however, it can also take place by supplying the plastics material parisons directly with the filling material and thus simultaneously expanding them.

FIG. 2 shows a cross-sectional representation of a system according to the invention. In this case a stretching rod 14 can also be seen, which serves to expand the plastics material parisons (not shown) in their longitudinal direction. The reference 16 designates a (blow) mold which is likewise a component of the transforming device. This (blow) mold has in its interior a hollow space inside which the plastics material parisons are expanded.

The reference numeral 20 in turn designates the clean room, which is delimited here by at least three walls 22, 24 and 26. The reference numeral 44 designates a further carrier for the blow mold. The reference 42 designates a driving device for moving the stretching rods 14.

The reference numeral 28 designates an outlet which functions as a draining device in order to draw off a product which has been sprayed inside the clean room. For this purpose the wall 24 is disposed obliquely, so that the sprayed filling material can flow directly to the outlet 28. In the region of the outlet a channel (not shown) can also be arranged inside the clean room, in order to collect the liquid drained off from the wall 24. Such a channel could extend here in a circular manner or perpendicular respectively to the drawing plane.

Below the outlet a collecting device 4, such as for example an annular channel, is provided, which collects the drained-off liquid. FIG. 3 shows a further embodiment of the system according to the invention. In this embodiment the handling station 2 is arranged obliquely relative to the vertical direction V. The wall 24 is also correspondingly oblique, in order to save space in this way. Also product sprayed over this oblique wall 24 can flow off in the direction of the outlet 28. Unlike what is shown in FIG. 3, the wall section 24a could also be disposed obliquely and running downwards towards the outlet 28, so that here too liquid can enter the collecting device 4.

FIG. 4 shows an embodiment which can be used in particular in a continuously running machine. In this case two water locks 52 and 54 are provided which seal the clean room 20 relative to the environment U. The first water lock 52 is disposed here so as to coincide with the outlet 28. In the embodiment shown in FIG. 4 the wall is arranged so as to be stationary. The station 2 together with the wall portions 22, 26 is arranged so as to be rotatable. As mentioned above, the clean room 20 is sealed by the two water locks 52 and 54 (only schematically illustrated in each case). Thus here in particular the water lock 52 also acts as a gas barrier which prevents entry in particular of unsterile air into the clean room.

FIG. 5 shows a further embodiment of a system according to the invention. In this embodiment a siphon, designated as a whole by 56 and in which a liquid F is arranged, adjoins the outlet 28. If liquid comes along via the outlet 28, this leads to a further portion of the liquid exiting towards the right in the direction of the outlet line 28. On the other hand, however, no gas escapes via the siphon 56. Thus in this embodiment the siphon serves as a gas barrier. This arrangement is particularly suitable for so-called clocked machines. It may be pointed out that the embodiments illustrated in FIGS. 4 and 5 can also be combined with the embodiments of FIGS. 2 and 3. This means that the embodiments illustrated in FIGS. 4 and 5 can also be used when the handling stations 2 are oriented vertically. The reference numeral 29 relates to a discharge device such as for instance a discharge pipe by means of which liquid can be discharged from the siphon 56.

The applicant reserves the right to claim all the features disclosed in the application documents as essential to the invention in so far as they are individually or in combination novel over the prior art. Furthermore it is pointed out that features which may be advantageous per se have also been described in the individual drawings. The person skilled in the art recognizes immediately that a specific feature described in a drawing may also be advantageous without the incorporation of further features from this drawing. Furthermore the person skilled in the art recognizes that advantages may also result from a combination of several features shown in individual drawings or in different drawings.

Numerous alterations, modifications, and variations of the preferred embodiments disclosed herein will be apparent to those skilled in the art and they are all anticipated and contemplated to be within the spirit and scope of the disclosed specification. For example, although specific embodiments have been described in detail, those with skill in the art will understand that the preceding embodiments and variations can be modified to incorporate various types of substitute and or additional or alternative materials, relative arrangement of elements, order of steps and additional steps, and dimensional configurations. Accordingly, even though only few variations of the method and products are described herein, it is to be understood that the practice of such additional modifications and variations and the equivalents thereof, are within the spirit and scope of the method and products as defined in the following claims. The corresponding structures, materials, acts, and equivalents of all means or step plus function elements in the claims below are intended to include any structure, material, or acts for performing the functions in combination with other claimed elements as specifically claimed.

We claim:

1. A system for handling containers comprising,
a movable carrier on which at least one handling station for handling the containers is arranged, wherein the handling station is transported along a predetermined transport path, and wherein the system has a clean room inside which the containers are handled, wherein
this clean room is delimited relative to an unsterile environment by at least one wall, characterized in that at least one wall of the clean room is at least in sections inclined relative to a horizontal plane in such a way that a liquid can be led out of the clean room along this wall.

2. The system according to claim 1, wherein the system has a draining device in order to drain off liquid from the clean room.

3. The system according to claim 1, wherein the system has a collecting device for collecting the liquid medium which is drained off out of the clean room or is to be drained off out of the clean room.

4. The system according to claim 1, wherein the system has at least one arrangement for supplying the containers with a gaseous medium and/or at least one arrangement for filling the containers.

5. The system according to claim 1, wherein the handling station has a filling element for filling the containers and a supply element for supplying the containers with a gaseous medium.

6. The system according to claim 1, wherein the system has a pressure generating device in order to generate an overpressure in the clean room relative to the unsterile environment.

7. The system according to claim 1, wherein the system has a gas barrier which prevents a gaseous medium from entering the clean room via the draining device.

8. The system according to claim 7, wherein the gas barrier is constructed as a siphon or as a water lock.

9. The system according to claim 7, wherein at least one handling station is oriented obliquely relative to a vertical direction.

10. A method for handling containers, wherein the containers are moved by means of handling stations along a predetermined transport path and wherein during handling the containers are transported at least intermittently inside a clean room, wherein the clean room is delimited relative to an unsterile environment by at least one wall, wherein a liquid is discharged at least intermittently from the clean room.
